(19) United States
(12) Patent Application Publication
(10) Pub. No.: US 2016/0329736 A1
(43) Pub. Date: Nov. 10, 2016

(54) SOLAR POWER SUPPLEMENTATION SYSTEM

(71) Applicant: Kevin Nichols, Turlock, CA (US)

(72) Inventor: Kevin Nichols, Turlock, CA (US)

(21) Appl. No.: 14/703,762

(22) Filed: May 4, 2015

(51) Int. Cl. H02J 7/35; H02J 3/00

(52) U.S. Cl. CPC H02J 7/35; H02J 3/005

(57) ABSTRACT

A solar power supplementation system for alternatively supplying a distribution transformer with electricity from a remote distribution substation and local solar panels. The solar power supplementation system comprises solar panels that are configured to supply electricity to the distribution transformer by way of a solar collection system and a switch. In operation, electricity generated by the solar panel is converted into a utility frequency alternating current and supplied to the electrical switch. The switch, which is additionally connected to the primary distribution lines selectively provides electricity from either the distribution substation (through the primary distribution lines) or the solar collection system based on whether the solar panels are producing sufficient stable current to meet the needs of the distribution transformer.

### BACKGROUND OF THE INVENTION

1. Field of the Invention

This invention relates generally to electrical power systems and, more particularly, to a solar power supplementation system for collecting and integrating solar power into an existing electrical power grid.

2. Description of the Prior Art

The components and design of a conventional electricity distribution system that carries electricity from the transmission system to individual consumers is well known. In many arrangements, distribution substations are used to connect to the transmission system and lower the transmission voltage, with distribution transformers then used to step down the voltage used in the distribution lines to the level used by the customer. A problem which still exists, however, is that in typical circumstances renewable energy sources must be included either at the final distribution stage by an end user or through a large scale input prior to the electricity passing through distribution substations. Thus, there remains a need for a solar power supplementation system which enables electricity generated by solar panels to be integrated at the distribution transformer stage. It would be helpful if such a solar power supplementation system employed photovoltaic solar panels at the site of discrete distribution transformers to supply electricity to the distribution transformer. It would be additionally desirable for such a solar power supplementation system to include an integration system that managed the input and use of electricity provided to the distribution transformer from the solar panels.

The Applicant's invention described herein provides for a solar power supplementation system adapted to allow the integration of solar power generated on location into a conventional electricity distribution system to supplement electricity from the transmission system. The primary components in Applicant's solar power supplementation system are a solar panels, a collection system, and a switch. When in operation, the solar power supplementation system enables solar generated electricity to be utilized directly by distribution transformers for sending to end users. As a result, many of the limitations imposed by prior art structures are removed.

### SUMMARY OF THE INVENTION

A solar power supplementation system for alternatively supplying a distribution transformer with electricity from a remote distribution substation and local solar panels. The solar power supplementation system comprises solar panels that are configured to supply electricity to the distribution transformer by way of a solar collection system and a switch. In operation, electricity generated by the solar panel is converted into a utility frequency alternating current and supplied to the electrical switch. The switch, which is additionally connected to the primary distribution lines selectively provides electricity from either the distribution substation (through the primary distribution lines) or the solar collection system based on whether the solar panels are producing sufficient stable current to meet the needs of the distribution transformer.

It is an object of this invention to provide a solar power supplementation system which enables electricity generated by solar panels to be integrated at the distribution transformer stage.

It is another object of this invention to provide a solar power supplementation system that employs photovoltaic solar panels at the site of discrete distribution transformers to supply electricity to the distribution transformer.

It is yet another object of this invention to provide a solar power supplementation system that includes an integration system that managed the input and use of electricity provided to the distribution transformer from the solar panels.

These and other objects will be apparent to one of skill in the art.

### BRIEF DESCRIPTION OF THE DRAWINGS

FIG. 1 shows a schematic of a solar power supplementation system built in accordance with a first embodiment of the present invention.

FIG. 2 shows a schematic of a solar power supplementation system built in accordance with a second embodiment of the present invention.

### DETAILED DESCRIPTION OF THE INVENTION

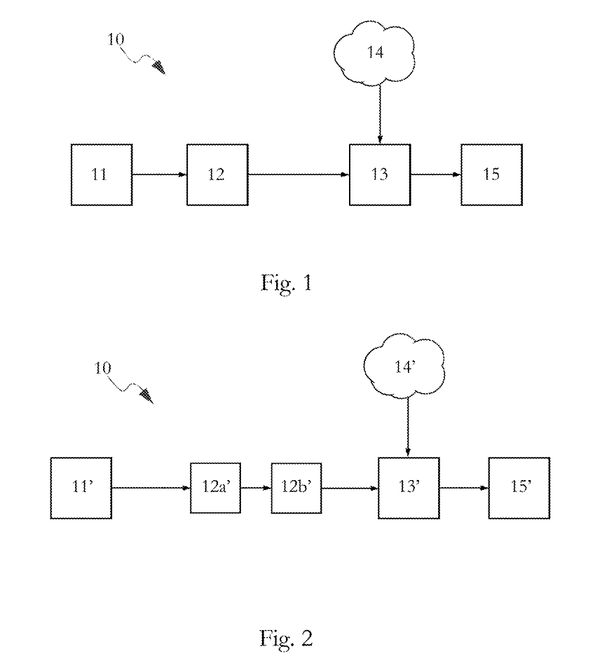

Referring now to the drawings and in particular FIG. 1, in one embodiment, a solar power supplementation system 10 includes solar panels 11 that are configured to supply electricity to a distribution transformer 15 by way of a solar collection system 12 and a switch 13. It is contemplated that the solar panels 11 comprise a single or array of conventional photovoltaic panels suitable to convert sunlight into electricity. The electricity generated by the solar panels 11 is directed to the solar collection system 12 where the variable direct current output of the solar panel 11 is converted into a utility frequency alternating current that can be fed into a commercial electrical grid. In the embodiment illustrated in FIG. 1, the solar collection system 12 defines a solar inverter.

Once the electricity generated by the solar panel 11 has been converted into a utility frequency alternating current, the solar collection system 12 supplies it to an electrical switch 13. The electrical switch 13 is additionally connected to the primary distribution lines carrying medium voltage power, generally from a distribution substation (not shown). Accordingly, the electrical switch 13 is wired to receive electricity from both the solar collection system 12 and the distribution substation. The electrical switch enables electricity from either the distribution substation or the solar collection system 12 to be supplied to the distribution transformer 15.

In operation, the switch 11 is constructed supply electricity from the distribution substation to the distribution transformer 15 unless sufficient the solar panels 11 are generating enough electricity that utility frequency alternating current can be supplied to the switch 13 by the solar collection system 12. Thus, whenever there is sufficient sunlight available that the solar panels 11 and solar collection system 12 can provide adequate electricity to the distribution transformer 15, the switch 13 interrupts current of electricity from the primary distribution lines and directs the electricity from the solar collection system 12 to the distribution transformer 15. Conversely, whenever sunlight is insufficient for the solar panels 11 and solar collection system 12 to provide adequate electricity to the distribution transformer 15, the switch 13 enables the current from the primary distribution lines to proceed to the distribution transformer 15.

It is appreciated that the primary distribution lines are generally connected directly to the distribution transformer 15 and thus by inserting the switch 13 between the distribution substation and the distribution transformer 15, the instant solar power supplementation system 10 can be deployed into existing power grid systems. It is contemplated, however, that a modified transformer may be employed in which the switching capability is already integrated so as to render the switch unnecessary.

In another embodiment, a solar power supplementation system 10′ includes a solar panels 11′ that is configured to supply electricity to a distribution transformer 15′ by way of a solar collection system and a switch 13′. As illustrated in FIG. 2, in this alternate embodiment, however, the solar collection system defines a discrete battery 12a′ and a power inverter 12b′ wired to collect and store electricity generated by the solar panels 11′ and, once the battery 12a′ is either full or reaches a predetermined level that is sufficient to supply electricity for an interval of time, convert the electricity to alternating current and direct it to the switch 13′. This alternate embodiment, is thereby structured to reduce the potential number of times the switch 13′ must break and make the electrical connection between the distribution transformer 15′ and primary power lines and distribution transformer 15′ and solar panel 11′, respectively.

It is contemplated that the solar panels, solar collection system, and switch arranged in accordance with the present invention will be present on site with the distribution transformer. Advantageously, for pole-mount transformers, the solar panels may be mounted on utility poles where they may be subjected to less obstructions than if they were lower to the ground.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A solar power supplementation system for use with pole-mounted transformers, comprising:
at least one solar panel, wherein each of said at least one solar panels are mounted on a utility pole; and
a solar collection system electrically connected to said at least one solar panel and configured to converted electricity generated by the at least one solar panel to a utility frequency alternating current suitable for feeding into a commercial electrical grid.

2. The solar power supplementation system of claim 1, additionally comprising a switch electrically connected to the solar collection system and power distribution lines that are suitable to supply electricity directly to a pole-mounted transformers, wherein said switch enables the solar collection system and the power distribution lines to be alternatively output.

3. The solar power supplementation system of claim 2, wherein said switch enables the solar collection system and the power distribution lines to be alternatively output based on whether the availability of electrical current from the solar collection system.

4. The solar power supplementation system of claim 2, wherein the solar collection system includes a solar inverter.

5. The solar power supplementation system of claim 2, wherein the solar collection system includes a battery and a power inverter.

6. The solar power supplementation system of claim 1, wherein the solar collection system includes a solar inverter.

7. The solar power supplementation system of claim 1, wherein the solar collection system includes a battery and a power inverter.
